(19) United States
(12) Patent Application Publication
(10) Pub. No.: US 2009/0079882 A1
(43) Pub. Date: Mar. 26, 2009

(54) ANALOG TV SIGNAL DECODING USING DIGITAL TUNER WITH I AND Q OUTPUT

(75) Inventor: YANBIN YU, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/861,243

(22) Filed: Sep. 25, 2007

(51) Int. Cl. H04N 5/50

(52) U.S. Cl. 348/732; 348/E05.108

(57) ABSTRACT

A dual use TV receiver for both analog TV and DTV using a digital tuner for processing analog signals and converting same to its respective I and Q components is provided. A method for producing a television receiver comprising the step of providing a digital tuner for processing analog signals to its respective I and Q components is provided.

### FIELD OF THE INVENTION

The present invention relates generally to communication devices or receivers. More specifically, the present invention relates to a mobile receiver suitable for analog TV signal decoding using digital tuner with the associated I, Q output.

### BACKGROUND

Separated analog tuner and digital tuner are known to be combined for use in receiving and displaying there respective signals. United States Patent Application No. 20070083903 to Wan el al describes an Audio/video system for a notebook computer.

Converting both analog television signal and digital television signal to an intermediate frequency signal for subsequent processing is known. U.S. Pat. No. 7,265,792 to Favrat, et al. describes a Television receiver for digital and analog television signals in which a television receiver includes a frequency conversion circuit, an analog-to-digital converter, a signal processor, and a signal output circuit. The frequency conversion circuit receives an input RF signal in one of several television signal formats and converts the input RF signal to an intermediate frequency signal. The analog-to-digital converter samples the intermediate frequency signal and generates a digital representation thereof. The signal processor processes the digital representation of the intermediate frequency signal in accordance with the television signal format of the input RF signal and generates digital output signals indicative of information encoded in the input RF signal. Finally, the signal output circuit receives the digital output signals from the signal processor and provides one or more output signals corresponding to the digital output signals. The signal output circuit can be configured to provide output signals corresponding to an analog television format or a digital television format or both.

The digital TV (DTV) and other digital communication systems make use of I (In-phase) and Q (Quatrature) components to represent and decode the full digital single side band signals. The Radio Frequency Integrated Circuit (RFIC), or tuner changes the incoming signal frequency, from typically several million mega HZ, into base-band, i.e. centered at zero HZ. For the spectral side band signal such as digitally modulated signals, I and Q components must be used.

For the analog signals, they are typically modulated using Vestigial Side-Band (VSB) methods with some residual spectral components in the other side of signal modulation frequency. The prior methods all decode the analog video signals using a single component. The complex I and Q representation may not be needed from theoretical point of view to decode the signals. But such representation can be easily used to correct the center frequency offset, simplify the tuner design and to improve the signal noise ratio (SNR).

Currently a lot of countries are transitioning from analog television signal to digital television signal. During the transition, both analog television signal and digital television signal may co-exist. Even after the transition analog signal still may exist for various purposes. Therefore, a digital television (DTV) receiver that can process analog television signal is desirable and sometime mandatory.

### SUMMARY OF THE INVENTION

A method for producing a television receiver comprising the step of providing a digital tuner for processing analog signals to its respective I and Q components is provided.

A dual use TV receiver for both analog TV and DTV using a digital tuner for processing analog signals and converting same to its respective I and Q components is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a first preferred embodiment in accordance with some embodiments of the invention.

FIG. 2 is an example of a second preferred embodiment in accordance with some embodiments of the invention.

FIG. 3 is an example of a process in accordance with some embodiments of the invention.

FIG. 4A is an example of first frequency responses of the analog signals in accordance with some embodiments of the invention.

FIG. 4B is an example of a second frequency response of the analog signals in accordance with some embodiments of the invention.

FIG. 5 is an example of a dual use receiver in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method for producing a television receiver comprising the step of providing a digital tuner for processing analog signals to its respective I and Q components. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of relating to a method for producing a television receiver comprising the step of providing a digital tuner for processing analog signals to its respective I and Q components. In the exemplified embodiments, it is noted that the processors include Finite State Machines, which are used in the preferred embodiment. The non-processor circuits may include, but are not limited to, a radio receiver, a radio transmitter, signal drivers, clock circuits, power source circuits, and user input devices. As such, these functions may be interpreted as steps of a method with reduced memory requirements to perform a method for producing a television receiver comprising the step of providing a digital tuner for processing analog signals to its respective I and Q components. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

This invention makes use of I and Q components to decode the analog TV signals. A set of dedicated filters are employed to reduce multi-path interference and enhance the signal to noise ratio (SNR) of the video signals as well as the audio signals.

Compared to pure DTV processing, when analog signals' respective I and Q components are converted into video signal's zero HZ and extracted, the higher frequency portion is not same as pure digital ones where the lower frequency portion is the same and somewhat redundant because of the VSB (Vestigial Single Band) modulations. The adjacent channel signals can be leaked into the signal. If the real centered frequency rather than the VSB signal's nominal central frequency is used to down-convert the signal, the above mentioned problems can be alleviated, but I and Q representation must be used.

The first step is to use the zero-IF, or the near-zero IF, architecture down-converter to convert the RF frequency signal into the base-band with I and Q components. After the low-pass filtering, the signals are converted into the digital domain. Then the signals splits into two paths (not shown), one is for the video. It is rotated into the base-band centered according the VSB modulations. Then it is filtered using match filter and equalizer to minimize the effects of multi-path and audio signals.

The other path (also not shown) is for the audio. The signal is again down-converted into the audio center frequency and filtered again. An FM decoding is performed similar to the extraction of the stereo audio signals like FM and others.

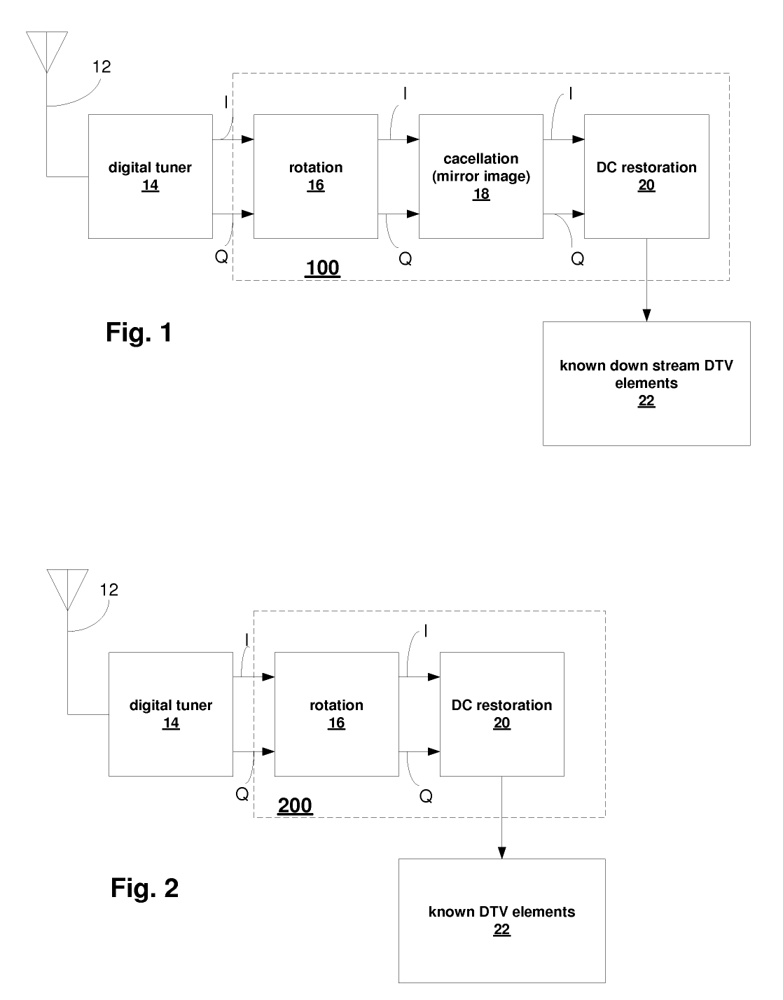

Referring to FIG. 1, a preferred embodiment of the present invention is shown. An antenna 12 receives an analog TV signals (both audio and video signals) that passes through a digital tuner 14. 14 converts the analog TV signals into their respective I and Q digital components, which forms the input to block 100. block 100 comprises a rotation block 16, a cancellation block 18, and a DC restoration block 20 with the I and Q signals passing in that order. rotation block 16 rotates the signals, cancellation block 18 cancels the mirror image, and 20 restored the direct current (DC) components necessary for restoring analog signals which is distinct from digital ones. The DC restoration is performed in such conditions as that if the digital tuner 14 is using zero IF method. Further, at this juncture, low pass filtering (LPF) can be applied. Furthermore, for analog TV such distortion is not acceptable. Therefore, some DC restoration circuit necessarily is required. The output of block 100 is then subject to known processes using DTV elements.

Referring to FIG. 2, a second embodiment of the present invention is shown. An antenna 12 receives an analog TV signals (both audio and video signals) that passes through a digital tuner 14. 14 converts the analog TV signals into their respective I and Q digital components, which forms the input to block 200. Block 200 comprises a rotation block 16, and a DC restoration block 20 with the I and Q signals passing in that order. Rotation block 16 rotates the signals, and 20 restored the DC components necessary for restoring analog signals which is distinct from digital ones. The output of block 200 is then subject to known processes using DTV elements.

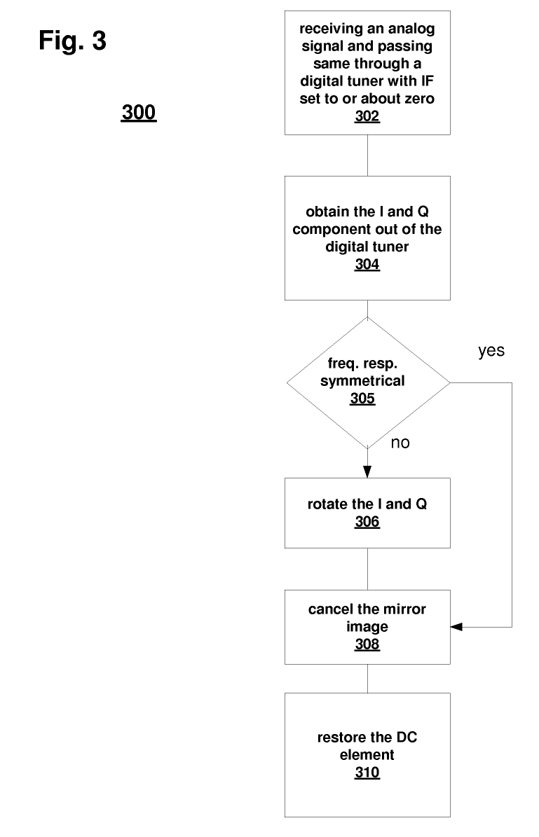

Referring to FIG. 3, a process 300 of the present invention is shown. Analog TV signals are received and pass through a digital tuner having intermediate frequency set either to zero, or about zero (Step 302). The output of the digital tuner in the form of I and Q components is obtained (Step 304). A determination is made as to whether the frequency response components are symmetrical (Step 305). If not, the I and Q components are rotated respectively (Step 306). Mirror image of the rotated I and Q components are canceled (Step 308). If true, the I and Q components skip the rotation step 306 and is subjected directly to the canceling step 308. At this juncture, the processed I and Q components are further subjected to a restoring action wherein the DC element are restored (Step 310). It is noted that the DC elements are significant in that for analog signals, the lack of which may significantly reduce the quality of either the video, or the audio output.

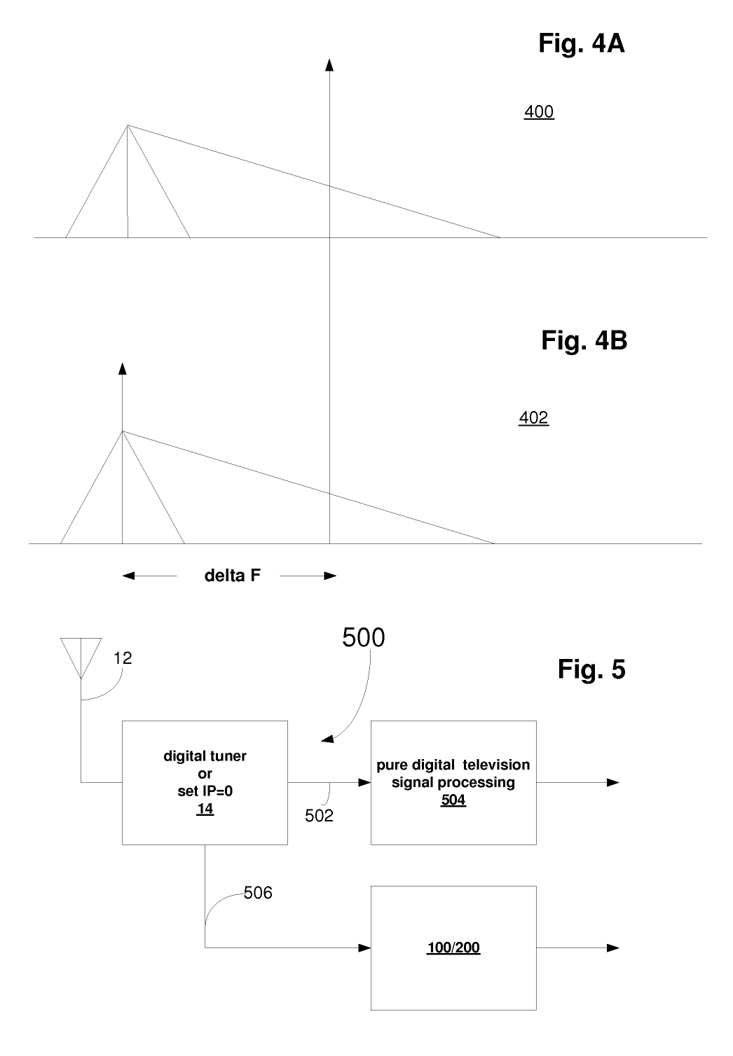

Referring to FIGS. 4A-4B, the Zero-IF conversion frequency responses of the analog signals are shown. In FIG. 4A, the frequency response 400 is symmetrical to a center, or center of the whole signal in frequency domain. Whereas in FIG. 4B, the frequency response 402 is un-symmetrical to a center, or zero frequency by a predetermined distance, i.e. ΔF. But it is centered into video signal's DC frequency. As can be seen, the Vestigial Side Band and central frequency (local oscillator's frequency) for the zero-IF architecture.

Referring to FIG. 5, a dual use receiver 500 is shown. Receiver 500 is adapted to be used for either analog TV receiving actions, DTV receiving actions, or both. An antenna 12 receives an analog TV signals (both audio and video signals) that passes through a digital tuner 14. digital tuner 14 converts the DTV signals into their respective I and Q digital components 502, which forms the input to the typical processes of pure digital television signal processing 504. Additionally, digital tuner 14 converts the analog TV signals into their respective I and Q digital components 506, which forms the input to block 100 of FIG. 1 or block 200 of FIG. 2 as the case be.

The processing bandwidth of the present invention is half of the received analog signal and makes the implementation of same easier and more cost effective. Further, for analog TV such distortion is not acceptable. So some DC restoration circuit must apply. In addition, the I and Q components make the frequency control operations easy as compared to pure analog or partial analog systems.

The present invention filters out some unwanted spectrum using some I and Q signal components in that the unwanted signal, which is not symmetric to the zero frequency is filtered. Also some dc restoration is performed for recovering some zero-frequency component.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for producing a television receiver comprising the step of providing a digital tuner for processing analog signal.

2. The method of claim 1 further comprising the step of rotating I and Q components output by the digital tuner.

3. The method of claim 1 further comprising the step of canceling I and Q components mirror image output by the digital tuner.

4. The method of claim 1 further comprising the step of restoring I and Q components direct current (DC) output by the digital tuner.

5. The method of claim 4, wherein the restoring step comprises recovering at least one zero-frequency component.

6. The method of claim 1, wherein a set of unwanted spectrum elements are removed using at least some I and Q elements that are not symmetric to a zero frequency.

7. The method of claim 1, wherein the method is wherein free from converting a received signal to an intermediate frequency (IF) for further processing.

8. The method of claim 1, wherein a processing bandwidth is half of a received analog signal.

9. A dual use receiver for receiving both analog and digital signals comprising a method for producing a television receiver comprising the step of providing a digital tuner for processing analog signal.

10. The receiver of claim 9, wherein the method further comprising the step of rotating I and Q components output by the digital tuner.

11. The receiver of claim 9, wherein the method further comprising the step of canceling I and Q components mirror image output by the digital tuner.

12. The receiver of claim 9, wherein the method further comprising the step of restoring I and Q components direct current (DC) output by the digital tuner.

13. The receiver of claim 12, wherein restoring step comprises recovering at least one zero-frequency component.

14. The receiver of claim 9, wherein a set of unwanted spectrum elements are removed using at least some I and Q elements that are not symmetric to a zero frequency.

15. The receiver of claim 9, wherein the method is wherein free from converting a received signal to an intermediate frequency (IF) for further processing.

16. The receiver of claim 9, wherein a processing bandwidth is half of a received analog signal.
